(19) United States
(12) Patent Application Publication
(10) Pub. No.: US 2020/0006911 A1
(43) Pub. Date: Jan. 2, 2020

(54) Doped Optical Fiber Amplifier And Working Method Thereof

(71) Applicant: O-NET Communications (Shenzhen) limited, Shenzhen (CN)

(72) Inventors: Kaiyuan Lu, Shenzhen (CN); Yimin Hua, Shenzhen (CN)

(21) Appl. No.: 16/537,650

(22) Filed: Aug. 12, 2019

Related U.S. Application Data
(63) Continuation of application No. PCT/CN2017/109282, filed on Nov. 3, 2017.

(30) Foreign Application Priority Data
Mar. 24, 2017 (CN) 201710184416.7

(51) Int. Cl. H01S 3/094; H01S 3/067; H01S 3/13

(52) U.S. Cl. CPC H01S 3/094; H01S 3/1301; H01S 3/06716

(57) ABSTRACT

The present disclosure provides a doped fiber amplifier and a working method thereof. The doped fiber amplifier including a seed source inputting signal light, a first isolator connected with the seed source, a coupler connected with the first isolator, a pump laser and a doped fiber connected with the coupler, a second isolator connected with the doped fiber, an optical splitter connected with the second isolator, and a connection head connected with the optical splitter. The connection head outputs a signal light of the seed source.

### TECHNICAL FIELD

The present disclosure relates to a field of pluggable laser radar light source technology, and in particular to a doped optical fiber amplifier and working method thereof.

### BACKGROUND

A laser radar is a radar system that emits a laser beam to detect a position and velocity of a target. At present, most of the laser radar light sources use a semiconductor laser with a wavelength of 905 nm. However, a frequency of the laser radar light sources is low, the safety threshold of the human eye is low, and the light source adopts an asynchronous operation mode during scanning. At present, the erbium doped fiber amplifier (EDFA) is designed as a single-stage erbium doped fiber amplifier with forward 980 nm and back 1480 nm bidirectional pumping.

### SUMMARY

The technical problem to be solved by the present disclosure is to provide a doped fiber amplifier and a working method thereof for realizing 1550 nm signal light amplification by a pump laser by using a rare earth doped fiber.

The present disclosure provides a doped fiber amplifier including a seed source inputting signal light, a first isolator connected with the seed source, a coupler connected with the first isolator, a pump laser and a doped fiber connected with the coupler, a second isolator connected with the doped fiber, an optical splitter connected with the second isolator, a connection head connected with the optical splitter. The connection head outputs the signal light of the seed source.

Furthermore, the optical splitter includes main path signal optical fibers and branch path signal optical fibers. All of the main path signal optical fibers are connected with the second isolator and the connection head.

Furthermore, the doped fiber amplifier includes a detector connected with the branch path signal optical fiber of the optical splitter

Furthermore, the detector is a photodiode.

Furthermore, the seed source is a laser with a wavelength of 1550 nm.

Furthermore, the coupler is a wavelength divider.

Furthermore, the doped fiber is doped dilute fiber.

Furthermore, the doped fiber amplifier is arranged in a pluggable optical module housing.

The present disclosure provides a working method of a doped fiber amplifier including steps:
emitting signal light, from a seed source to a first isolator;
passing through the first isolator, and the signal light is transmitted to a coupler unidirectionally;
providing energy to the coupler by a pump laser;
coupling the input signal light and energies provided by the pump laser into a doped fiber by the coupler;
inputting the signal light and the energies to a second isolator by the doped fiber, and passing through the second isolator to the optical splitter unidirectionally; and
outputting the signal light from the optical splitter through a detector, while outputting the signal light to a connector.

The present disclosure realizes 1550 nm signal light amplification by the pump laser with the use of the doped dilute fiber, and a repetition frequency of the 1550 nm laser can reach megahertz. Further, the laser has a high water absorption coefficient, when the wavelength laser irradiates person eyes, the damage threshold to the human eyes is high, thus, the laser of the band has human eyes safety characteristics. In addition, the light source uses a standard pluggable optical module package form, and has broad application prospects in fields of automatic driving and 3D scanning.

### BRIEF DESCRIPTION OF DRAWINGS

FIG. 1 is a schematic diagram showing a structure of a doped fiber amplifier of the present disclosure.

### DETAILED DESCRIPTION

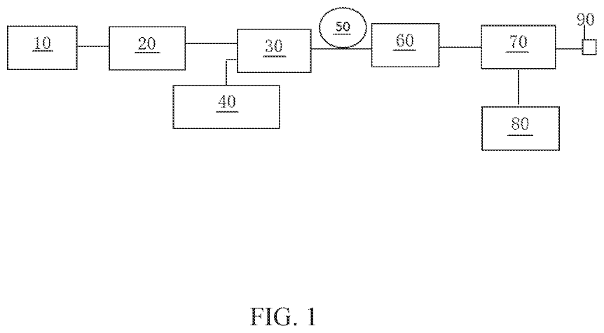

As shown in FIG. 1, the present disclosure provides a doped fiber amplifier including a seed source 10 inputting signal light, a first isolator 20 connected with the seed source 10, a coupler 30 connected with the first isolator 20, a pump laser 40 and a doped fiber 50 connected with the coupler 30, a second isolator 60 connected with the doped fiber 50, an optical splitter 70 connected with the second isolator 60, a detector 80 connected with the optical splitter 70, and a connection head 90 connected with the optical splitter 70. The connection head 90 outputs the signal light of the seed source 10.

In one embodiment, the coupler 30 is a wavelength divider. The function of the coupler 30 is to couple an input signal and an pump light into the doped fiber 50, and transfers an energy of the pump light into the input optical signal through the doped fiber 50 to realize amplification of the input optical signal.

In one embodiment, the doped fiber 50 is doped dilute fiber 50. Dilute ions are activated to amplify the optical signal in a 1550 nm operating window with low optical transmission loss.

In one embodiment, the seed source is a laser with a wavelength of 1550 nm. An pigtail (fiber) of the seed source 10 is welded with an pigtail (fiber) of the first isolator 20. The pigtail (fiber) of the first isolator 20 is welded with a pigtail (signal fiber) of the coupler 30. A pigtail (fiber) of the pump laser 40 is welded with a pigtail (pump fiber) of the coupler 30. The doped fiber 50 is welded with a pigtail (fiber) of the second isolator 60.

In one embodiment, the optical splitter 70 includes main path signal optical fibers and branch path signal optical fibers. The pigtail (fiber) of the second isolator 60 is fused with a pigtail (main signal fiber) of the optical splitter 70. A pigtail (shunt signal fiber) of the optical splitter 70 is fused with a pigtail (fiber) of the detector 80. A pigtail (main road signal fiber) of the optical splitter 70 is welded with an output terminal connector 90 (optical fiber).

In one embodiment, the detector 80 ensures that the entire doped fiber amplifier operates within a predetermined output optical power. The detector is a photodiode.

The present disclosure provides a working method includes steps:
Step 1: emitting signal light, from a seed source 10 to a first isolator 20;
Step 2: passing through the first isolator 20, and the signal light is transmitted to a coupler 30 unidirectionally;
Step 3: providing energy to the coupler 30 by a pump laser 40;
Step 4: coupling the input signal light and energies provided by the pump laser 40 into the doped fiber 50 by the coupler 30;
Step 5: inputting the signal light and the energies to a second isolator 60 by the doped fiber 50, and passing through the second isolator 60 to the optical splitter 70 unidirectionally; and
Step 6: outputting the signal light from the optical splitter 70 through a detector, while outputting the signal light to a connector.

The present disclosure realizes 1550 nm signal light amplification by the pump laser 40 with the use of doped dilute fiber 50, and the repetition frequency of the 1550 nm laser can reach megahertz. Further, the laser has a high-water absorption coefficient, when the wavelength laser irradiates person eyes, the damage threshold to the human eyes is high, thus, the laser of the band has human eyes safety characteristics. In addition, the light source uses a standard pluggable optical module package form, and has broad application prospects in fields of automatic driving and 3D scanning.

The optics and electronics of the laser radar source are packaged in standard pluggable optical module housings (e.g. SFP, SFP+, XFP, CFP, CFP2, etc.), which is communicated and module controlled using standard MSA protocols through gold fingers.

The above content is a further detailed description of the present disclosure in conjunction with the specific preferred embodiments, and the specific implementation of the present disclosure is not limited to the description. It will be apparent that equivalent changes or modifications made in accordance with the scope of the present disclosure, which should be considered as being within the scope of the present disclosure.

What is claimed is:

1. A doped fiber amplifier comprising a seed source inputting signal light, a first isolator connected with the seed source, a coupler connected with the first isolator, a pump laser and a doped fiber connected with the coupler, a second isolator connected with the doped fiber, an optical splitter connected with the second isolator, and a connection head connected with the optical splitter; wherein the connection head outputs the signal light of the seed source.

2. The doped fiber amplifier according to claim 1, wherein the optical splitter comprises main path signal optical fibers and branch path signal optical fibers, all of the main path signal optical fibers are connected with the second isolator and the connection head.

3. The doped fiber amplifier according to claim 2, wherein the doped fiber amplifier comprising a detector connected with the branch path signal optical fiber of the optical splitter

4. The doped fiber amplifier according to claim 3, wherein the detector is a photodiode.

5. The doped fiber amplifier according to claim 1, wherein the seed source is a laser with a wavelength of 1550 nm.

6. The doped fiber amplifier according to claim 1, wherein the coupler is a wavelength divider.

7. The doped fiber amplifier according to claim 1, wherein the doped fiber is doped dilute fiber.

8. The doped fiber amplifier according to claim 1, wherein the doped fiber amplifier is arranged in a pluggable optical module housing.

9. A working method of a doped fiber amplifier, comprising steps:
emitting signal light, from a seed source to a first isolator;
passing through the first isolator, and the signal light is transmitted to a coupler unidirectionally;
providing energy to the coupler by a pump laser;
coupling the input signal light and energies provided by the pump laser into a doped fiber by the coupler;
inputting the signal light and the energies to a second isolator by the doped fiber, and passing through the second isolator to the optical splitter unidirectionally; and
outputting the signal light from the optical splitter through a detector, while outputting the signal light to a connector
